(19) United States
(12) Patent Application Publication
(10) Pub. No.: US 2016/0099668 A1
(43) Pub. Date: Apr. 7, 2016

(54) Motor Control Circuit System

(71) Applicant: Der-San Chen, Tainan City (TW)

(72) Inventor: Der-San Chen, Tainan City (TW)

(21) Appl. No.: 14/852,617

(22) Filed: Sep. 13, 2015

(30) Foreign Application Priority Data
Oct. 1, 2014 (TW) 103134306

(51) Int. Cl. H02P 6/18

(52) U.S. Cl. CPC H02P 6/182

(57) ABSTRACT

A motor control circuit system is arranged to control the activation of a motor when a rotating voltage of the motor equals to a predetermined threshold so as to save the power consumption of the motor, wherein no current is allowed to pass to the motor before the rotating voltage of the motor reaches again the predetermined threshold. Therefore, the motor is electrified in an interval manner, such that the driven mechanism runs with its inertia even though the motor is idle, i.e. no current passing to the motor, so as to save the energy output of the motor.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a motor circuit system, in particular, an energy saving controlling circuit system for motor.

2. Description of Related Arts

An existing driven mechanism is generally driven by a motor. When a driving voltage is continuously supplied to the motor, the motor will transform a rotational voltage into a sine wave form. In other words, when the driving voltage from the driven mechanism is greater than zero, the motor is actuated. Therefore, the driving voltage must be continuously supplied to the motor whether the driven mechanism runs or not. As a result, it is a waste of energy when the driven mechanism is in an idle condition. In this case, the driven mechanism can run by inertia without the power output of the motor through the continuously supply of the driving voltage.

Accordingly the existing motor is designed to self-generate a rotational power for the rotor at an initiate state when the actual voltage to the motor is insufficient or reduced. In particular, such design of the existing motor is controlled by a timer relay and its setting of time period (such as after certain seconds). For example, the timer relay will switch on a MCD (Magnetic Contact DELTA) and switch off a MCM (Magnetic Contact MAIN) to short the feedback circuit, so as to power up the motor at a full rotationally loading speed. Even though such design mainly uses a timing method to energize the motor efficiently, it cannot completely respond to the voltage change for the rotational speed and cannot controllably stop the power output of the motor.

### SUMMARY OF THE PRESENT INVENTION

An objective of the present invention is to provide a motor control circuit system for driving a driven mechanism, which comprises:
a motor driven by an alternating current;
a control electrically connected to the motor, wherein the control is activated to let the AC current to the motor and to stop the AC current to the motor;
a processor unit electrically linked to the control, wherein the processor unit comprises a voltage controlling module;
a sensor electrically linked to the processor unit; and
a converter electrically linked to the processor unit, wherein the voltage controlling module controls the current passing to the motor when a rotating voltage of the motor reaches a predetermined threshold, and the voltage controlling module stops the current passing to the motor before the rotating voltage of the motor reaches again the predetermined threshold.

With the design and configuration of the present invention, the motor will generate an output only when the rotating voltage of the motor at the predetermined threshold. Therefore, no current will pass to the motor before the rotating voltage of the motor reaches again the predetermined threshold. In other words, the motor is electrified in an interval manner, such that the driven mechanism will run with its inertia even though the motor is idle (no current), so as to save the energy output of the motor. Since the sensor of the present invention does not depend on time detection as the conventional configuration, the sensor can provide an actual dynamic detection to improve its reliability comparing with the conventional timer counting device.

These and other objectives, features, and advantages of the present invention will become apparent from the following detailed description, the accompanying drawings, and the appended claims.

### BRIEF DESCRIPTION OF THE DRAWINGS

FIG. 1 is a diagram of a system according to a preferred embodiment of the present invention.

FIG. 2 is a diagram illustrating an output of the system according to the above preferred embodiment of the present invention.

FIG. 3 is a circuit diagram illustrating the system according to the above preferred embodiment of the present invention.

FIG. 4 is a diagram illustrating the wave transformation of the system according to the above preferred embodiment of the present invention.

FIG. 5 is a first diagram illustrating the power consumption of the system according to the above preferred embodiment of the present invention.

FIG. 6 is a second diagram illustrating the power consumption of the system according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

With the aids of the Figures shown below, the content of techniques, features, and embodiments of the present invention is herein described, so as for the examiners to further understand the present invention.

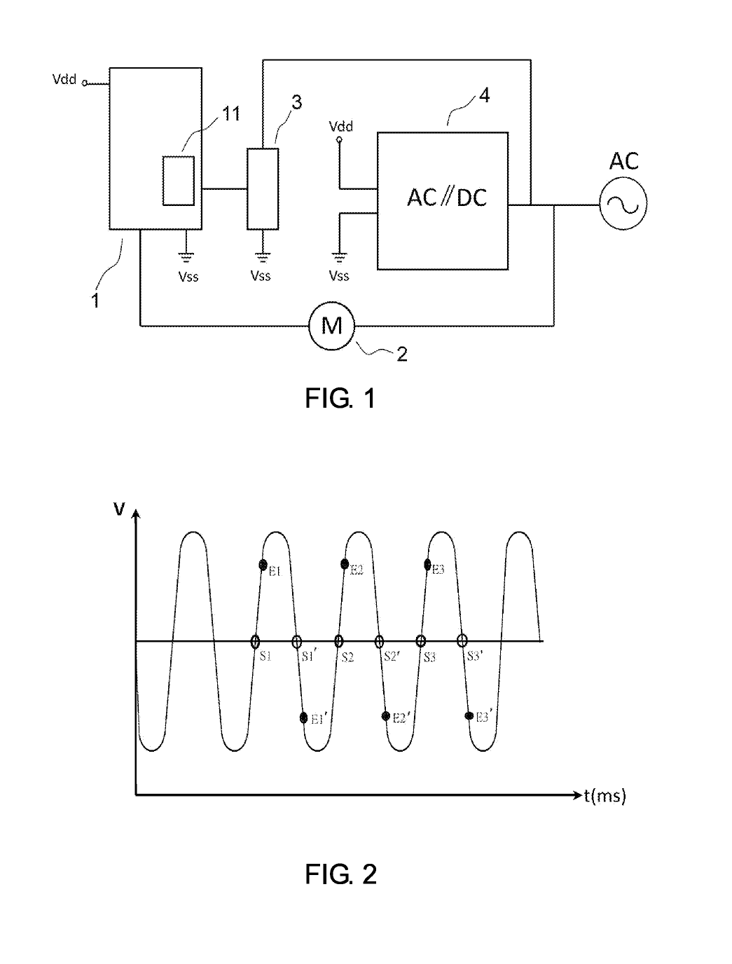

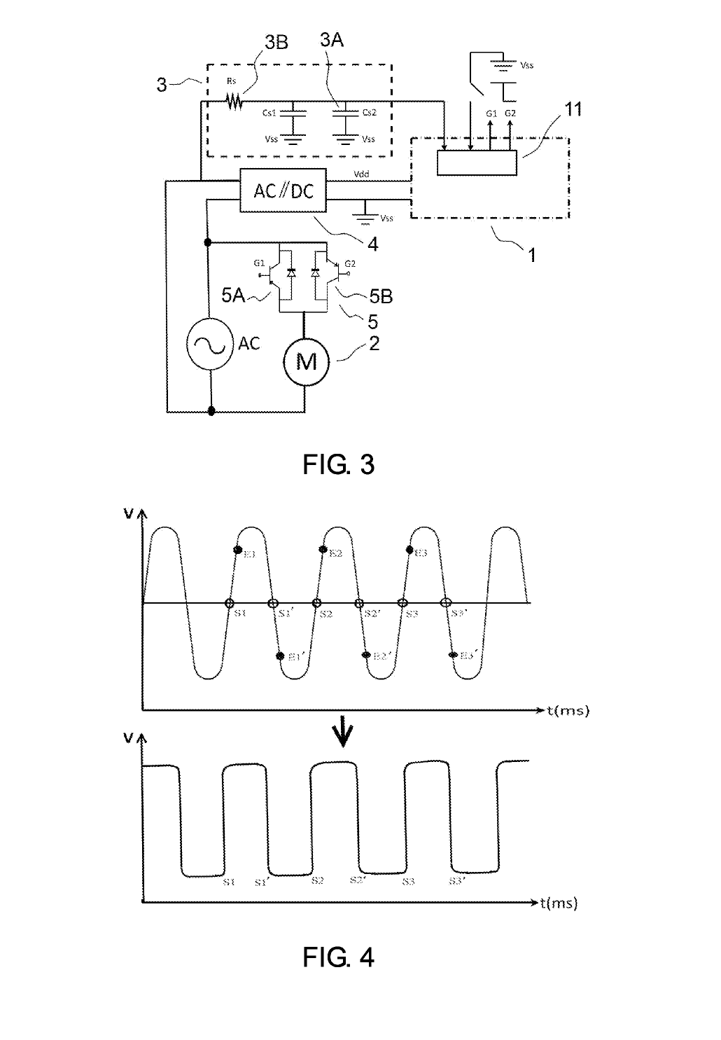

Referring to FIGS. 1 and 3 of the drawings, a control circuit system of a motor 2 according to a preferred embodiment of the present invention is illustrated, wherein the motor 2 is configured for driving a driven mechanism, such as an electric fan, an electric power tool, a compressor, a washer, a spin-drier, a dryer, a food processor, a refrigerator, and other mechanisms that can be driven with the motor.

The present invention comprises a motor 2, a control 5, a processor unit 1, a sensor 3, and a converter 4.

The motor 2 is driven by an alternating current.

The control 5, which serves as a switch, is electrically connected to the motor 2, wherein the control 5 is activated to control a supply the AC current to the motor 2. In particular, the control 5 is activated to let the AC current to the motor 2 and to stop the AC current to the motor 2. The control 5 comprises an ascending sine wave controller switch 5A and a descending sine wave control switch 5B. A safety control switch (not shown in drawings) is optionally connected to the control 5 to electrically connect to the processor unit 1, such that when a state change of the control 5 after it is electrified, the control 5 can initially activate the motor 2 under a certain condition. A reversible current switch (not shown in drawings) is optionally connected to the control 5 for supplying reverse current to the motor 2, so as to enable a rotor of the motor 2 to rotate reversibly.

The processor unit 1 is electrically linked to the control 5, wherein the processor unit 1 comprises a voltage controlling module 11. Preferably, the voltage controlling module 11 can be a software or a program to be installed.

The sensor 3 is electrically linked to the control 5, wherein the sensor comprises a resistance 3B and two sensing capacitors 3A electrically connected with each other.

The converter 4 is electrically linked to the control 5 and the processor unit 1. Accordingly, the voltage controlling module 11 is activated, such as executing the program, to electrify the motor 2 when the rotating voltage of the motor 2 reaches a predetermined threshold. Therefore, the voltage controlling module 11 will control the current passing to the motor 2 when the rotating voltage of the motor 2 reaches the predetermined threshold. Then, before the rotating voltage of the motor 2 reaches again the predetermined threshold, the voltage controlling module 11 will stop the current passing to the motor 2. In other words, the voltage controlling module 11 will let the current passing to the motor 2 when the rotating voltage of the motor 2 equals to the predetermined threshold and the voltage controlling module 11 will stop the current passing to the motor 2 when the rotating voltage of the motor 2 different to the predetermined threshold.

As shown in FIG. 2, the rotating voltage of the motor 2 is configured to have a starting threshold START (S1) and an end threshold END (E1) to save the power consumption of the motor 2. Preferably, the stating threshold is set at zero value. Before the rotating voltage of the motor 2 reaches START (S1′) from START (S1), the current is stopped passing through the motor 2. In other words, the motor 2 is electrified in an interval manner, such that the driven mechanism will run with its inertia even though the motor 2 is idle (no current), so as to save the energy output of the motor 2. In addition, the sensor 3 will accurately detect the rotating voltage change of the motor 2, such that the sensor 3 is electrically linked to the processor unit 1 to form a comparison module for enhance the accuracy and reliability thereof. Since the sensor 3 of the present invention does not depend on time detection as the conventional configuration, the sensor 3 can provide an actual dynamic detection to improve its reliability comparing with the conventional timer counting device.

Accordingly, the reference power supply of the sensor 3 and the reference power supply of the processing unit 1 are at the same level. Therefore, an accurate value will be obtained by applying the same measuring basis.

According to the preferred embodiment, the starting threshold of the motor 2 is set as zero value and the sensor 3 is arranged for detecting zero voltage of the motor 2 regarding the sine wave thereof. The starting threshold of the motor 2 set as zero value is to obtain the best energy saving efficiency.

As shown in FIG. 4, the sensor 3 of the present invention is arranged to convert the electrical wave of the motor 2 from the sine waveform into a square waveform, so as to further detect the rotating voltage of the motor 2 regarding in time process. In particular, the sensor 3 will detect the starting threshold of the motor 2 at zero value and the higher voltage value (greater than the starting threshold) in a process of time.

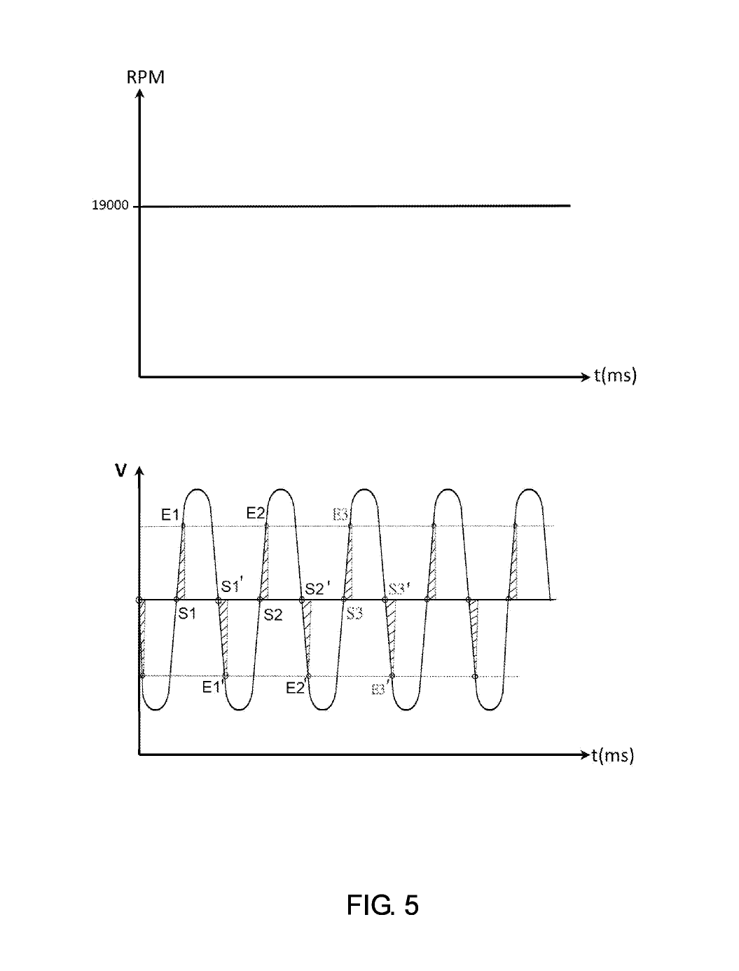

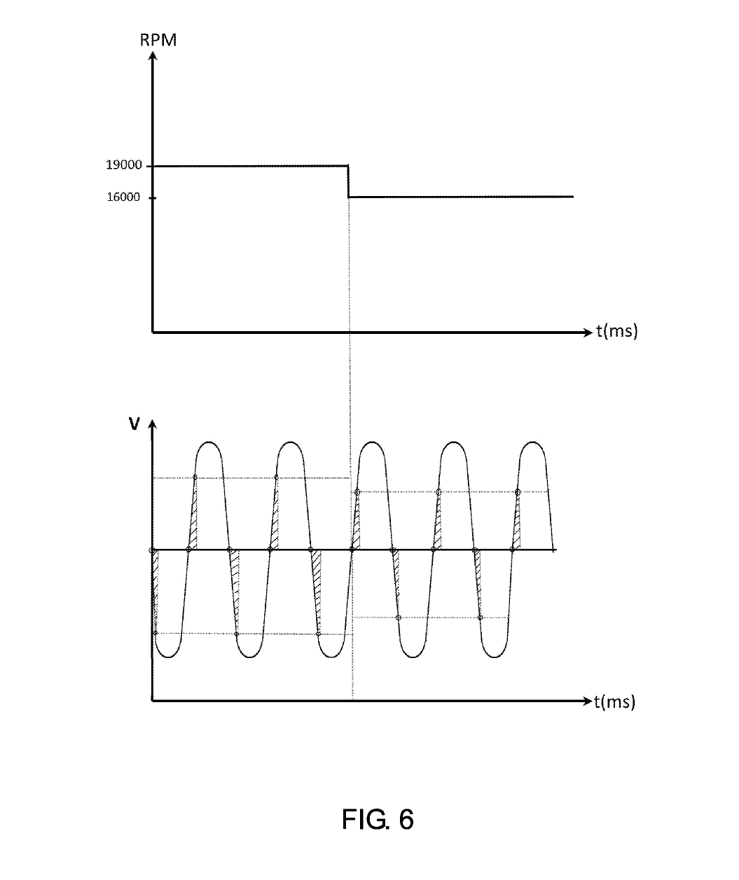

FIG. 5 illustrates the electrical consumption of the motor 2. When the rotational speed of the driven mechanism is at 19,000 RPM, the electrical consumption of the present invention will be shown at the shaded area. In other words, the power demand for operating the motor 2 will be greatly reduced. As shown in FIG. 6, when the rotational speed of the driven mechanism is reduced to 16,000 RPM, the energy consumption of the present invention can be controlled and reduced accordingly. In other words, the motor 2 can be initially started at zero voltage, wherein the current can be stopped passing to the motor 2 at any point of the ascending or descending sine wave. For example, the current will be stopped passing to the motor 2 at a designated point at the ascending sine wave via the ascending sine wave controller switch or at the descending sine wave via the descending sine wave control switch.

According to the preferred embodiment, the voltage controlling module 11 is continuously activated (executed) to repeatedly let the current passing to motor 2 and stop the current passing to motor 2. The voltage controlling module 11 can alter the time between the current passing to motor 2 and the current stopped passing to the motor 2. As a result, the rotational speed of the motor 2 will be correspondingly and continuously changed according to the voltage level of the motor 2, so as to produce turbulent flow in fluid. For example, the motor 2 at the food processor to chop the food evenly, the motor 2 at the electric fan to generate a natural airflow, or the motor 2 at the electric washer to generate an even spinning movement for prevent the clothes being tangled.

The motor (2) of the present invention can also be extensively applied to three-phase motor. With a more accurate calculation and more sensors, it can achieve better energy efficiency.

All in all, the present invention certainly fits industrial applicability and has not been published or used in public before the application. It also has not been known by the public, but has non-obviousness, which meets the requirements of patentability, so it is lawfully submitted to apply for a patent accordingly.

However, the above descriptions are only a preferred embodiment of the present invention industrially, but all equivalent varieties and modifications based on the appended claims of the present invention are within the scope of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A motor control circuit system for a driven mechanism, which comprises:
a motor driven by an alternating current;
a control electrically connected to said motor, wherein said control is activated to let the current to said motor and to stop the current to said motor;
a processor unit electrically linked to said control, wherein said processor unit comprises a voltage controlling module;
a sensor electrically linked to said processor unit; and
a converter electrically linked to said processor unit, wherein said voltage controlling module controls the current passing to said motor when a rotating voltage of said motor reaches a predetermined threshold, and said voltage controlling module stops the current passing to said motor before said rotating voltage of said motor reaches again the predetermined threshold.

2. The motor control circuit system, as recited in claim 1, wherein said voltage controlling module is a program being executed to continuously and repeatedly let the current passing to said motor and stop the current passing to said motor.

3. The motor control circuit system, as recited in claim 1, wherein said voltage controlling module further alters a time between the current passing to motor and the current stopped passing to the motor.

4. The motor control circuit system, as recited in claim 1, wherein said predetermined threshold is set as zero value that said sensor is to detect zero rotating voltage of said motor in a sine waveform.

5. The motor control circuit system, as recited in claim 1, wherein said motor is a three-phase motor.

6. The motor control circuit system, as recited in claim 1, wherein said sensor convert an electrical wave of said motor from the sine waveform into a square waveform.

7. The motor control circuit system, as recited in claim 1, wherein said sensor comprises at least a sensing capacitor.

8. The motor control circuit system, as recited in claim 1, wherein a reference power supply of said sensor and a reference power supply of said processing unit are at the same level.

9. The motor control circuit system, as recited in claim 1, wherein said control further comprises an ascending sine wave controller switch and a descending sine wave control switch.

10. The motor control circuit system, as recited in claim 1, further comprising a safety control switch electrically connected to said processor unit for initially activating said motor under a safety condition.
